(19) United States
(12) Patent Application Publication
(10) Pub. No.: US 2009/0192069 A1
(43) Pub. Date: Jul. 30, 2009

(54) Washing or Cleaning Composition with Size-Optimized Active Bleaching Ingredient Particles

(75) Inventors: Heike Schirmer-Ditze, Duesseldorf (DE); Doris Dahlmann, Duesseldorf (DE)

Correspondence Address: Ratner Prestia, P.O. Box 980, Valley Forge, PA, 19482, US

(73) Assignee: Henkel AG & Co, KGaA, Duesseldorf (DE)

(21) Appl. No.: 12/360,534

(22) Filed: Jan. 27, 2009

Related U.S. Application Data
(63) Continuation of application No. PCT/EP2007/056918, filed on Jul. 9, 2007.

(30) Foreign Application Priority Data
Aug. 4, 2006 (DE) 10 2006 036 896.7

(51) Int. Cl. C11D 17/06

(52) U.S. Cl. 510/446

(57) ABSTRACT

A bleaching agent, as well as a bleach-intensifying transition metal complex compound, incorporated in shelf-stable fashion into agents made up of multiple powder components. A solid washing detergent or cleaning agent containing particulate alkali percarbonate having an average particle size in the range from 1.0 to 2.0 mm, and particles that contain a bleach-intensifying transition metal complex compound, having an average particle size in the range from 0.8 mm to 1.6 mm.

### CROSS-REFERENCE TO RELATED APPLICATIONS

This application is a continuation under 35 U.S.C. §§ 120 and 365(c) of International Application PCT/EP2007/056918, filed on Jul. 9, 2007. This application also claims priority under 35 U.S.C. § 119 of DE 10 2006 036 896.7, filed on Aug. 4, 2006. The disclosures of PCT/EP2007/056918 and DE 10 2006 036 896.7 are incorporated herein by reference in their entirety.

### BACKGROUND OF THE INVENTION

The present invention relates to solid washing detergents or cleaning agents that contain alkali percarbonate and a bleach-intensifying transition metal complex compound.

Inorganic peroxygen compounds, in particular hydrogen peroxide and solid peroxygen compounds that dissolve in water with the release of hydrogen peroxide, such as sodium perborate and sodium carbonate perhydrate, have been used for some time as oxidizing agents for disinfection and bleaching purposes. The oxidizing effect of these substances in dilute solutions depends greatly on temperature; with H₂O₂ or perborate in alkaline bleaching baths, for example, sufficiently rapid bleaching of soiled textiles is achieved only at temperatures above approximately 80° C. At lower temperatures, the oxidizing effect of the inorganic peroxygen compounds can be improved by the addition of so-called bleach activators, for which numerous proposals have been disclosed in the literature, principally from the substance classes of the N- or O-acyl compounds, for example multiply acylated alkylenediamines, in particular tetraacetylethylenediamine, acylated glycourils, in particular tetraacetylglycouril, N-acylated hydantoins, hydrazides, triazoles, hydrotriazines, urazoles, diketopiperazines, sulfurylamides and cyanurates, also carboxylic acid anhydrides, in particular phthalic acid anhydride, carboxylic acid esters, in particular sodium nonanoyl oxybenzenesulfonate, sodium isononanoyl oxybenzenesulfonate, and acylated sugar derivatives such as pentaacetylglucose. By the addition of these substances, the bleaching effect of aqueous peroxide baths can be enhanced sufficiently that the effects that occur at temperatures around 60° C. are already substantially the same as with the peroxide bath alone at 95° C.

In the context of efforts toward energy-saving washing and bleaching methods, application temperatures well below 60° C., in particular below 45° C. and down to cold-water temperature, have become more significant in recent years.

At these low temperatures, the effect of the hitherto known activator compounds generally declines perceptibly. There has therefore been no lack of efforts to develop more-effective activators for this temperature range. One starting point for this emerges from the use of transition-metal salts and complexes as proposed e.g. in European Patent Applications EP 0 392 592 A2, EP 0 443 651 A2, EP 0 458 397 A2, EP 0 544 490 A1, or EP 0 549 271 A1, as so-called bleach catalysts. With these the risk exists, presumably because of the high reactivity of the oxidizing intermediates produced from them and from the peroxygen compounds, of color changes in colored textiles and, in extreme cases, of oxidizing textile damage. European Patent Application EP 0 272 030 A2 describes cobalt(III) complexes with ammonia ligands, which can furthermore comprise any further uni-, bi-, tri-, or tetradentate ligands, as activators for H₂O₂ for use in textile washing or bleaching agents. International Patent Applications WO 96/23859, WO 96/23860, and WO 96/23861 relate to the use of corresponding Co(III) complexes in agents for automatic dishwashing. European Patent Application EP 630 964 A2 discloses specific manganese complexes that have no pronounced effect in terms of bleach intensification of peroxygen compounds and do not decolor colored textile fibers, but can produce bleaching of coloring matter or dirt, dissolved from the fibers, that is present in washing baths. German Patent Application DE 44 16 438 A1 discloses manganese, copper, and cobalt complexes that can carry ligands from a number of substance groups and are to be used as bleach catalysts and oxidation catalysts. International Patent Application WO 97/07191 proposes complexes of manganese, iron, cobalt, ruthenium, and molybdenum, having ligands of the salen type, as activators for peroxygen compounds in cleaning solutions for hard surfaces.

The use of such transition metal catalysts has hitherto been complicated, in practical terms, by the need to incorporate the bleaching agent, and also the catalyst, in shelf-stable fashion into a composition made up of multiple powder components. Shelf stability must be ensured both in the chemical sense, i.e. neither the bleaching agent nor the complex must decompose or break down the other ingredients of the compositions during storage, and in the physical sense, meaning that the mixture of different particulate components must not separate out so that, for example, one component builds up at the bottom, another component in the middle, and a third component at the top of the packaging container, and when only a portion of the entire composition is removed from the container, that part does not correspond to the overall composition of the composition. Chemical stability can be improved, for example, by encasing the particles, among other actions. The problem of physical stability can be circumvented, for example, by making available to the consumer pre-portioned quantities of the composition for one application: if the entire portion is used at once, it is immaterial whether that portion is a homogeneous or a heterogeneous particle mixture. Portioning both into pouches made of water-soluble material and into tear-open pouches made of water-insoluble material is conceivable for this purpose. This workaround is, however, disadvantageous simply because of the additional packaging outlay.

It might possibly be expected that the more similar the sizes of particles made of different materials, the less the particles will demix. Based on our experimental results, however, this conceptual approach is not sufficient to arrive in actuality at shelf-stable mixtures of alkali percarbonate particles and bleach catalyst particles. The absolute size of the particles instead has a decisive influence. If that size is correctly selected, the particles contained in the smaller quantity should in fact not be of the exact same size as the other particles, but instead should be smaller. They should, however, be nowhere near small enough to fit into the interstices of an accumulation of the larger particles.

### DESCRIPTION OF THE INVENTION

The subject matter of the present invention is a solid washing detergent or cleaning agent containing particulate alkali percarbonate having an average particle size in the range from 1.0 to 2.0 mm, in particular from 1.2 to 1.8 mm, and particles that contain a bleach-intensifying transition metal complex compound, having an average particle size in the range from 0.8 mm to 1.6 mm, in particular from 0.9 to 1.5 mm.

The average particle sizes cited both here and hereinafter are averages by weight.

As a general rule, the particulate alkali percarbonate is contained in the composition according to the present invention in larger quantities than the particles having the bleach-intensifying transition metal complex compound. The particulate alkali percarbonate then preferably has an average particle size 0.05 to 0.4 mm, in particular 0.1 mm to 0.25 mm, larger than that of the particles that contain the bleach-intensifying transition metal complex compound.

The composition according to the present invention can additionally contain further particulate components. To ensure particularly reliably in that case that the alkali percarbonate particles and complex compound particles not only do not demix from one another, but also do not separate during storage from the other particulate components, the additional further particulate components by preference likewise have an average particle size in the range from 1.0 mm to 2.0 mm, in particular from 1.2 mm to 1.8 mm.

Washing detergents according to the present invention can be used as such in automatic or manual washing methods, but can also be utilized as washing-detergent additives and/or as washing or textile pretreatment compositions.

As a washing-detergent additive, compositions according to the present invention are used together with a usual washing detergent. This is useful especially when the user wishes to improve the bleaching performance of the usual washing detergent. In the context of washing pretreatment, the compositions according to the present invention are used to improve the removal of encrusted dirt or spots, especially “problem” spots such as coffee, tea, red wine, grass, or fruit juice, which are difficult to remove by washing with usual textile washing agents but are accessible to oxidative attack. A further field of application of such compositions is the removal of local stains on otherwise clean surfaces, so that a more laborious operation of washing or cleaning the entire corresponding article, be it a garment or a carpet or a piece of upholstery, can be avoided. For this purpose, it is easy to apply a composition according to the present invention, together with a quantity of water not sufficient for complete dissolution of the composition, onto the textile surface or the portion thereof to be cleaned; optionally to introduce mechanical energy, for example by rubbing with a cloth or a sponge; and then, after a time to be defined by the user, to remove the composition and the oxidatively decomposed stain by rinsing with water, for example with the aid of a moistened cloth or sponge.

In a preferred embodiment the composition according to the present invention is made up, in particular for utilization as a washing-detergent additive and/or as a pretreatment agent, of 15 wt % to 35 wt % particulate alkali percarbonate, which optionally can be converted into granulate form with the aid of small concentrations of alkali carbonate, alkali sulfate, and/or alkali silicate and/or can be encased therewith; 60 wt % to 80 wt % particulate alkali carbonate; up to 5 wt %, by preference 0.5 wt % to 2.5 wt %, complexing agents for heavy metals, which optionally can be part of the alkali-carbonate and/or alkali-percarbonate particles; and 0.5 wt % to 5 wt %, in particular 0.7 wt % to 3 wt %, particles containing a bleach-intensifying transition metal complex compound.

In addition, however, the washing detergents and cleaning agents can in principle also contain, by preference as constituents of the aforesaid further particulate component(s), all known ingredients that are usual in such agents. The washing detergents and cleaning agents according to the present invention can contain, in particular, builder substances, surface-active surfactants, enzymes, sequestering agents, electrolytes, pH regulators, polymers having specific effects, such as soil release polymers, color transfer inhibitors, graying inhibitors, wrinkle-reducing active substances and shape-retention active substances, and further adjuvants such as optical brighteners, foam regulators, additional peroxygen activators, dyes, and fragrances.

Suitable transition metal complex compounds are, in particular, those of the metals Fe, Mn, Co, V, Ru, Ti, Mo, W, Cu, and/or Cr, for example the manganese-, iron-, cobalt-, ruthenium-, or molybdenum-salen complexes known from German Patent Application DE 195 29 905 A1 and their N-analog compounds known from German Patent Application DE 196 20 267 A1, the manganese, iron, cobalt, ruthenium, or molybdenum carbonyl complexes known from German Patent Application DE 195 36 082 A1, the manganese, iron, cobalt, ruthenium, molybdenum, titanium, vanadium, and copper complexes having nitrogen-containing tripod ligands described in German Patent Application DE 196 05 688 A1, the cobalt, iron, copper, and ruthenium ammine complexes known from German Patent Application DE 196 20 411 A1, the manganese, copper, and cobalt complexes described in German Patent Application DE 44 16 438 A1, the cobalt complexes described in European Patent Application EP 0 272 030 A2, the manganese complexes known from European Patent Application EP 0 693 550 A2, the manganese, iron, cobalt, and copper complexes known from European Patent Application EP 0 392 592 A2, and/or the manganese complexes described in European Patent Application EP 0 443 651 A2 or European Patent Applications EP 0 458 397 A2, EP 0 458 398 A2, EP 0 549 271 A1, EP 0 549 272 A1, EP 0 544 490 A1, and EP 0 544 519 A2.

Included among the preferred bleach-intensifying transition metal complex compounds are manganese complexes having ligands of the salen type, for example those of formula (I) below:

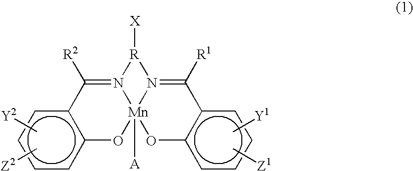

in which
R denotes an alkylene, alkenylene, phenylene, or cycloalkylene group that in addition to the substituent X can, optionally, be alkyl- and/or aryl-substituted, having a total of 1 to 12 carbon atoms, the shortest spacing within R between the nitrogen atoms being 1 to 5 carbon atoms,
X denotes —H, —OR³, —NO₂, —F, —Cl, —Br, or —I;
R¹, R², and R³ mutually independently, denote hydrogen or an alkyl group having 1 to 4 carbon atoms;
Y¹ and Y² mutually independently, denote hydrogen or an electron-shifting substituent;
Z¹ and Z² mutually independently, denote hydrogen, —CO₂M, —SO₂M, or NO₂;
M denotes hydrogen or an alkali metal such as lithium, sodium, or potassium; and
A denotes a charge-equalizing ligand that, depending on its charge and on the nature and number of the other charges, in particular the charge of the central manganese atom, can also be absent or can be present more than once.

Optionally, the bridge labeled R in this formula can also contain a nitrogen atom and can then connect three salicylideneimide structures, for example as reproduced below (without the substituents R¹, R², Y¹, Y², Z¹, and Z², and the anion ligand A):

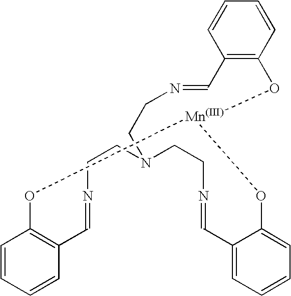

The third salicylideneimide structure can also comprise substituents which correspond to the substituents R¹, Y¹, and Z¹, at the corresponding locations reproduced in the salicylideneimide structures according to formula I.

If desired, although less preferably, other transition metals such as, for example, Fe, Co, Ni, V, Ru, Ti, Mo, W, Cu, and/or Cr can be present instead of the central Mn atom in such complex compounds of the salen type.

In a further preferred embodiment, the bleach-intensifying transition metal complex compound corresponds to the general formula (II):

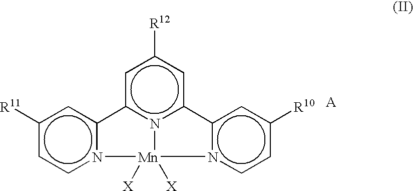

in which R¹⁰ and R¹¹, mutually independently, denote hydrogen, a C₁₋₈ alkyl group, an —NR¹³R¹⁴ group, an —N⁺R¹³R¹⁴R¹⁵ group, or a

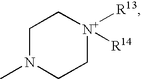

group, R¹² denotes hydrogen, —OH, or a C₁₋₈ alkyl group, R¹³, R¹⁴, and R¹⁵, mutually independently, denote hydrogen, a C₁₋₄ alkyl or hydroxyalkyl group, and X denotes halogen, and A denotes a charge-equalizing anion and otherwise has the meaning indicated for formula (I). As in the complexes according to formula (I), the manganese can exhibit oxidation state II, III, IV, or V.

The compositions according to the present invention preferably contain 0.01 wt % to 0.5 wt %, in particular 0.02 wt % to 0.3 wt %, bleach-intensifying transition metal complex.

The particles containing the bleach-intensifying transition metal complex need not be made entirely thereof, but can contain inert carrier materials for the complex compound. Included among such carrier materials are, for example, inorganic salts such as the alkali and alkaline-earth chlorides, carbonates, sulfates, silicates, and phosphates, organic materials such as polyvinyl alcohol, starch, cellulose, anionic and nonionic starch ethers or cellulose ethers such as carboxymethyl cellulose, methyl cellulose, hydroxyethyl cellulose, and corresponding starch ethers. Also suitable in addition to cellulose powders are silk powder, wool powder, nylon, powder, and polyurethane powder. In order to package the bleach-intensifying transition metal complex compound together with carrier materials into particles, it is possible to use, in a manner that is usual in principle, binding agents, for example polyethylene glycols and/or film-forming organic polymers of the polymeric polycarboxylate type. If desired, the particles can also contain dyes or pigment, and/or they can be coated, in a manner that is usual in principle, with one or more encasing materials. A carrier-material-containing particle of this kind preferably contains at least 1 wt %, by preference 2 wt % to 50 wt %, in particular 5 wt % to 20 wt %, bleach-intensifying transition metal complex compound. It is important that, in the context of the carrier-material-containing particles, which can be obtained e.g. by extrusion, accumulative granulation in a mixer or fluidized bed, or by milling operations, the manufacturing parameters be selected so that the resulting particles possess the indicated size. If necessary, particles that do not meet the specification essential to the invention can be removed by sieving. By preference, at least 80 wt %, in particular at least 85 wt % of the particles that contain the bleach-intensifying transition metal complex compound have a particle size in the range from 0.8 to 1.6 mm. It is further preferred that less than 20 wt % of the particles that contain the bleach-intensifying transition metal complex compound have a particle size less than 0.8 mm.

The particulate alkali percarbonate contained in the compositions according to the present invention is by preference used in the form of encased alkali percarbonate particles that comprise an alkali percarbonate core that can have been produced in accordance with any manufacturing method and that can also contain stabilizers known per se, such as magnesium salts, silicates, and phosphates. The manufacturing methods that are usual in practice are, in particular, so-called crystallization methods as well as fluidized-bed spray granulation methods. In the crystallization method, hydrogen peroxide and alkali carbonate in the aqueous phase are converted to alkali percarbonate, and the latter is separated from the aqueous mother liquor after crystallization. Whereas in earlier methods, alkali percarbonate was crystallized out in the present of a higher concentration of an inert salt such as sodium chloride, methods are now also known in which crystallization can also take place in the absence of a salting-out agent. Reference is made, for example, to European Patent Application EP 0 703 190. In fluidized-bed spray granulation, an aqueous hydrogen peroxide solution and an aqueous alkali carbonate solution are sprayed onto alkali carbonate seeds that are present in a fluidized bed, and water is simultaneously evaporated. The granulated material growing in the fluidized bed is withdrawn from the fluidized bed all together or in sorted fashion. Reference is made to International Patent Application WO 96/06615 for examples of one such manufacturing method. Lastly, alkali percarbonate that has been produced by a method encompassing contact between solid alkali carbonate, or a hydrate thereof, and an aqueous hydrogen peroxide solution, and drying, can also be the core of the alkali percarbonate particle.

A particulate alkali percarbonate that is contained in particularly preferred fashion in the compositions according to the present invention comprises at least two encasing layers, such that an innermost layer contains at least one hydrate-forming inorganic salt, and an outer layer contains alkali silicate. The outer encasing layer containing alkali silicate can be either the outermost encasing layer of a casing encompassing at least two layers, or an encasing layer that is not the innermost one located directly on the alkali percarbonate and can be overlaid in turn by one or more layers. Although individual layers are discussed here as in the existing art, it must be noted that the constituents of the superimposed layers can transition into one another at least in the boundary region. This at least partial penetration results from the fact that during the coating of alkali percarbonate particles that comprise an innermost encasing layer, the latter is partly dissolved at least superficially when a solution that contains an encasing component, or the encasing components, of a second encasing layer, is sprayed on. With alkali percarbonate as well, particles that do not meet the specification essential to the invention can be removed, if necessary, by sieving. By preference, less than 10 wt %, in particular less than 5 wt %, of the particulate alkali percarbonate is present as particles having diameters greater than 2.0 mm. It is further preferred that less than 40 wt %, in particular less than 35 wt %, of the particulate alkali percarbonate be particles having diameters less than 1.0 mm. A composition according to the present invention contains by preference 15 wt % to 50 wt %, in particular 18 wt % to 35 wt %, alkali percarbonate.

In addition to the bleach-intensifying transition metal complex compound, further compounds known as bleach-activating active substances can, if desired, be used in the compositions according to the present invention, in particular conventional bleach activators, i.e. compounds that, under perhydrolysis conditions, yield optionally substituted perbenzoic acids and/or peroxocarboxylic acids having 1 to 10 carbon atoms, in particular 2 to 4 carbon atoms. Usual bleach activators that carry O- and/or N-acyl groups having the aforesaid number of carbon atoms, and/or that carry optionally substituted benzoyl groups, are suitable. Multiply acylated alkylenediamines, in particular tetraacetylethylenediamine (TAED), acylated glycolurils, in particular tetraacetylglycoluril (TAGU), acylated triazine derivatives, in particular 1,5-diacetyl-2,4-dioxohexahydro-1,3,5-triazine (DADHT), acylated phenolsulfonates, in particular nonanoyloxy- or isononanoyloxybenzenesulfonate, acylated polyvalent alcohols, in particular triacetin, ethylene glycol diacetate, and 2,5-diacetoxy-2,5-dihydrofuran, as well as acetylated sorbitol and mannitol, and acylated sugar derivatives, in particular pentaacetylglucose (PAG), pentaacetylfructose, tetraacetylxylose and octaacetyllactose, as well as acetylated, optionally N-alkylated glucamine und gluconolactone, are preferred. Nitriles forming perimidic acids under perhydrolysis conditions, for example acetonitriles carrying ammonium groups, can also be used. By preference, however, the compositions according to the present invention are free of such conventional bleach activators.

The compositions according to the present invention can contain one or more surfactants; anionic surfactants, nonionic surfactants, and mixtures thereof are particularly suitable. Suitable nonionic surfactants are, in particular, alkyl glycosides and ethoxylation and/or propoxylation products of alkyl glycosides, or linear or branched alcohols each having 12 to 18 carbon atoms in the alkyl portion and 3 to 20, by preference 4 to 10, alkyl ether groups. Also usable are corresponding ethoxylation and/or propoxylation products of N-alkylamines, vicinal diols, fatty acid esters and fatty acid amides that correspond with regard to the alkyl portion to the aforesaid long-chain alcohol derivatives, and of alkylphenols having 5 to 12 carbon atoms in the alkyl group.

Suitable anionic surfactants are, in particular, soaps, and those that contain sulfate or sulfonate groups having preferably alkali ions as cations. Usable soaps are preferably the alkali salts of the saturated or unsaturated fatty acids having 12 to 18 carbon atoms. Such fatty acids can also be used in incompletely neutralized form. Included among the usable surfactants of the sulfate type are the salts of the sulfuric acid semiesters of fatty alcohols having 12 to 18 carbon atoms, and the sulfatizing products of the aforesaid nonionic surfactants having a low degree of ethoxylation. Included among the usable surfactants of the sulfonate type are linear alkylbenzenesulfonates having 9 to 14 carbon atoms in the alkyl portion, alkanesulfonates having 12 to 18 carbon atoms, and olefinsulfonates having 12 to 18 carbon atoms that are produced upon reaction of corresponding monoolefins with sulfur trioxide, as well as alpha-sulfofatty acid esters that are produced upon sulfonation of fatty acid methyl or ethyl esters.

Such surfactants are contained in the cleaning agents or washing detergents according to the present invention in quantitative proportions of, by preference, 5 wt % to 50 wt %, in particular 8 wt % to 30 wt %.

A composition according to the present invention preferably contains at least one water-soluble and/or water-insoluble, organic and/or inorganic builder. Included among the water-soluble organic builder substances are polycarboxylic acids, in particular citric acid and sugar acids, monomeric and polymeric aminopolycarboxylic acids, in particular methylglycinediacetic acid, nitrilotriacetic acid, and ethylenediaminetetraacetic acid, as well as polyaspartic acid, polyphosphonic acids, in particular aminotris(methylenephosphonic acid), ethylenediaminetetrakis(methylenephosphonic acid), and 1-hydroxyethane-1,1-diphosphonic acid, polymeric hydroxy compounds such as dextrin and (poly)carboxylic acids, in particular the polycarboxylates, accessible by the oxidation of polysaccharides or dextrins, of International Patent Application WO 93/16110, International Patent Application WO 92/18542, or European Patent EP 0 232 202, polymeric acrylic acids, methacrylic acids, maleic acids, and mixed polymers thereof, which can also contain, polymerized into them, small concentrations of polymerizable substances without carboxylic-acid functionality. The relative molecular weight of the homopolymers of unsaturated carboxylic acids is generally between 5000 and 200,000, that of the copolymers between 2000 and 200,000, by preference 50,000 to 120,000, based in each case on free acid. A particularly preferred acrylic acid/maleic acid copolymer has a relative molecular weight from 50,000 to 100,000. Suitable (although less preferred) compounds of this class are copolymers of acrylic acid or methacrylic acid with vinyl ethers, such as vinylmethyl ethers, vinyl esters, ethylene, propylene, and styrene, in which the proportion of acid is at least 50 wt %. It is also possible to use, as water-soluble organic builder substances, terpolymers that contain two unsaturated acids and/or salts thereof as monomers and, as a third monomer, vinyl alcohol and/or an esterified vinyl alcohol or a carbohydrate. The first acid monomer or its salt is derived from an ethylenically monounsaturated C₃ to C₈ carboxylic acid and by preference from a C₃ to C₄ monocarboxylic acid, in particular from (meth)acrylic acid. The second acid monomer or its salt can be a derivative of a C₄ to C₈ dicarboxylic acid (maleic acid being particularly preferred) and/or a derivative of an allylsulfonic acid that is substituted in the 2-position with an alkyl or aryl group. Such polymers generally have a relative molecular weight between 1000 and 2000. Further preferred copolymers are those that comprise, as monomers, by preference acrolein and acrylic acid/acrylic acid salts, or vinyl acetate. All the aforesaid acids are generally used in the form of their water-soluble salts, in particular their alkali salts.

Organic builder substances of this kind can be contained, if desired, in quantities of up to 40 wt %, in particular up to 25 wt %, and by preference from 1 wt % to 8 wt %.

Suitable water-soluble inorganic builder materials are, in particular, polymeric alkali phosphates, which can be present in the form of their alkaline, neutral, or acid sodium or potassium salts. Examples thereof are tetrasodium diphosphate, disodium dihydrogendiphosphate, pentasodium triphosphate, so-called sodium hexametaphosphate, and the corresponding potassium salts, or mixtures of sodium and potassium salts. Crystalline or amorphous alkali aluminosilicates are used in particular as water-insoluble, water-dispersible inorganic builder materials, in quantities of up to 50 wt %, by preference not above 40 wt %, and in liquid compositions in particular from 1 wt % to 5 wt %. Among these, the crystalline sodium aluminosilicates of washing-detergent quality, in particular zeolite A, P, and optionally X, are preferred. Quantities close to the aforesaid upper limit are used by preference in solid, particulate compositions. Suitable aluminosilicates exhibit, in particular, no particles having a particle size greater than 30 μm, and by preference are made up of at least 80 wt % particles having a size less than 10 μm. Their calcium binding capability, which can be determined as indicated in German Patent DE 24 12 837, is generally in the range from 100 to 200 mg CaO per gram.

Suitable substitutes or partial substitutes for the aforesaid aluminosilicate are crystalline alkali silicates, which can be present alone or mixed with amorphous silicates. The alkali silicates usable in the detergents as detergency builders have by preference a molar ratio of alkali oxide to SiO₂ below 0.95, in particular from 1:1.1 to 1:12, and can be present in amorphous or crystalline fashion. Preferred alkali silicates are the sodium silicates, in particular the amorphous sodium silicates, having a Na₂O:SiO₂ molar ratio from 1:2 to 1:2.8. Crystalline sheet silicates of the general formula Na₂SiₓO₂ₓ₊₁. yH₂O, in which x, the so-called modulus, is a number from 1.9 to 4 and y is a number from 0 to 20, and preferred values for x are 2, 3, or 4, are preferred for use as crystalline silicates, which can be present alone or mixed with amorphous silicates. Preferred crystalline sheet silicates are those in which x in the aforesaid general formula assumes the values 2 or 3. In particular, both β- and δ-sodium disilicates (Na₂Si₂O₅.yH₂O) are particularly preferred. Practically anhydrous crystalline alkali silicates manufactured from amorphous alkali silicates and having the aforesaid general formula, in which x denotes a number from 1.9 to 2.1, can be used in compositions according to the present invention. In a further preferred embodiment of compositions according to the present invention, a crystalline sodium sheet silicate having a modulus from 2 to 3 is used, which silicate can be manufactured from sand and soda. Crystalline sodium silicates having a modulus in the range from 1.9 to 3.5 are used in a further preferred embodiment of compositions according to the present invention. In a preferred embodiment of compositions according to the present invention, a granular compound of alkali silicate and alkali carbonate is used, for example as obtainable commercially under the name Nabion® 15. If alkali aluminosilicate, in particular zeolite, is also present as an additional builder substance, the weight ratio of aluminosilicate to silicate, based in each case on anhydrous active substances, is by preference 1:10 to 10:1. In compositions that contain both amorphous and crystalline alkali silicates, the weight ratio of amorphous alkali silicate to crystalline alkali silicate is by preference 1:2 to 2:1, and in particular 1:1 to 2:1.

Builder substances are contained in the washing detergents or cleaning agents according to the present invention by preference in quantities of up to 60 wt %, in particular from 5 to 40 wt %, while the disinfecting compositions according to the present invention are by preference free of the builder substances that merely complex water-hardness components, and preferably contain not more than 20 wt %, in particular from 0.1 wt % to 5 wt %, heavy-metal-complexing substances, by preference from the group encompassing aminopolycarboxylic acids, aminopolyphosphonic acids, and hydroxypolyphosphonic acids and water-soluble salts thereof, and mixtures thereof.

In a preferred embodiment of the invention, a composition according to the present invention comprises a water-soluble builder block. The use of the term “builder block” here is intended to express the fact that the compositions contain no further builder substances other than those that are water-soluble, i.e. all the builder substances contained in the composition are combined into the “block” thus characterized; an exception is made, if necessary, for quantities of substances that may be contained in commercially usual fashion in small quantities, as contaminants or as stabilizing additives, in the other ingredients of the composition. The term “water-soluble” is to be understood in this context to mean that the builder block, at the concentration resulting from the utilization quantity of the composition containing it under usual conditions, dissolves without residue. By preference, at least 15 wt % and up to 55 wt %, in particular 25 wt % to 50 wt %, water-soluble builder block is present in the compositions according to the present invention. This is preferably made up of the following components:
a) 5 wt % to 35 wt % citric acid, alkali citrate, and/or alkali carbonate, which can also be replaced at least in part by alkali hydrogencarbonate;
b) up to 10 wt % alkali silicate having a modulus in the range from 1.8 to 2.5;
c) up to 2 wt % phosphonic acid and/or alkali phosphonate;
d) up to 50 wt % alkali phosphate; and
e) up to 10 wt % polymeric polycarboxylate,
   the quantitative indications referring to the entire washing detergent or cleaning agent. This also applies to all quantitative indications hereinafter unless expressly indicated otherwise.

In a preferred embodiment of compositions according to the present invention, the water-soluble builder block contains at least two of components b), c), d), and e) in quantities greater than 0 wt %.

With regard to component a), 15 wt % to 25 wt % alkali carbonate, which can be replaced at least in part by alkali hydrogencarbonate, and up to 5 wt %, in particular 0.5 wt % to 2.5 wt %, citric acid and/or alkali citrate, are contained in a preferred embodiment of compositions according to the present invention. In an alternative embodiment of compositions according to the present invention, 5 wt % to 25 wt %, in particular 5 wt % to 15 wt %, citric acid and/or alkali citrate and up to 5 wt %, in particular 1 wt % to 5 wt %, alkali carbonate, which can be replaced at least in part by alkali hydrogencarbonate, are contained. If both alkali carbonate and alkali hydrogencarbonate are present, component a) comprises alkali carbonate and alkali hydrogencarbonate by preference at a weight ratio from 10:1 to 1:1.

With regard to component b), 1 wt % to 5 wt % alkali silicate having a modulus in the range from 1.8 to 2.5 is contained in a preferred embodiment of compositions according to the present invention.

With regard to component c), 0.05 wt % to 1 wt % phosphonic acid and/or alkali phosphonate is contained in a preferred embodiment of compositions according to the present invention. “Phosphonic acids” are also understood in this context as optionally substituted alkylphosphonic acids that can also comprise several phosphonic-acid groups (so-called polyphosphonic acids). They are preferably selected from the hydroxy- and/or aminoalkylphosphonic acids and/or alkali salts thereof such as, for example, dimethylaminomethanediphosphonic acid, 3-aminopropane-1-hydroxy-1,1-diphosphonic acid, 1-amino-1-phenylmethanediphosphonic acid, 1-hydroxyethane-1,1-diphosphonic acid, amino-tris(methylenephosphonic acid), N,N,N′,N′-ethylenediaminetetrakis(methylenephosphonic) acid, and the acylated derivatives of phosphoric acid described in German Examined Application DE 11 07 207, which can also be used in any desired mixtures.

With regard to component d), 15 wt % to 35 wt % alkali phosphate, in particular trisodium polyphosphate, is contained in a preferred embodiment of compositions according to the present invention. “Alkali phosphate” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance. Sodium dihydrogenphosphate, NaH₂PO₄, exists as the dihydrate (density 1.91 gcm⁻³ melting point 60°) and as the monohydrate (density 2.04 gcm⁻³). Both salts are white powders that are very easily soluble in water that lose their water of crystallization upon heating; they transition at 200° C. into the weakly acid diphosphate (disodium hydrogendiphosphate, Na₂H₂P₂O₇), and at higher temperature into sodium trimetaphosphate (Na₃P₃O₉) and Maddrell's salt. NaH₂PO₄ reacts in acid fashion; it is created when phosphoric acid is adjusted with sodium hydroxide to a pH of 4.5 and the mash is spray-dried. Potassium dihydrogenphosphate (primary or unibasic potassium phosphate, potassium diphosphate, KDP), KH₂PO₄, is a white salt of density 2.33 gcm⁻³, has a melting point of 253° (decomposing to form potassium polyphosphate (KPO₃)ₓ), and is easily soluble in water. Disodium hydrogenphosphate (secondary sodium phosphate), Na₂HPO₄, is a colorless, very easily water-soluble crystalline salt. It exists anyhdrously and with 2 mol (density 2.066 gcm⁻³, water lost at 95°), 7 mol (density 1.68 gcm⁻³, melting point 48° with loss of 5H₂O), and 12 mol of water (density 1.52 gcm⁻³, melting point 35° with loss of 5H₂O); it becomes anhydrous at 100°, and when further heated transitions into the diphosphate Na₄P₂O₇. Disodium hydrogenphosphate is produced by neutralizing phosphoric acid with a soda solution using phenolphthalein as indicator. Dipotassium hydrogenphosphate (secondary or dibasic potassium phosphate), K₂HPO₄, is an amorphous white salt that is easily soluble in water. Trisodium phosphate (tertiary sodium phosphate), Na₃PO₄, exists as colorless crystals that as the dodecahydrate have a density of 1.62 gcm⁻³ and a melting point of 73 to 76° C. (decomposition), as the decahydrate (corresponding to 19 to 20% P₂O₅) a melting point of 100° C., and in anhydrous form (corresponding to 39 to 40% P₂O₅) a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning-agent industry. Tetrasodium diphosphate (sodium pyrophosphate), Na₄P₂O₇, exists in anhydrous form (density 2.534 gcm⁻³, melting point 988°, also indicated as 880°) and as the decahydrate (density 1.815 to 1.836 gcm⁻³, melting point 94° with loss of water). Both substances are colorless crystals that are soluble in water with an alkaline reaction. Na₄P₂O₇ is created when disodium phosphate is heated to >200°, or by reacting phosphoric acid with soda in the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25°. Condensation of NaH₂PO₄ or KH₂PO₄ yields higher-molecular-weight sodium and potassium phosphates, within which a distinction can be made between cyclic representatives (the sodium and potassium metaphosphates) and chain types (the sodium and potassium polyphosphates). For the latter in particular, a number of designations are in use: fused or thermal phosphates, Graham salt, Kurrol's salt, and Maddrell's salt. All the higher sodium and potassium phosphates are together referred to as “condensed” phosphates. The technically important pentasodium triphosphate Na₅P₃O₁₀ (sodium tripolyphosphate) is a white, water-soluble, non-hygroscopic salt, crystallizing anhydrously or with 6H₂O, of the general formula NaO—[P(O)(ONa)—O]ₙ—Na, where n=3. Approximately 17 g of the salt containing no water of crystallization dissolves in 100 g of water at room temperature, approx. 20 g at 60° C., and approx. 32 g at 100°; after the solution is heated to 100° for two hours, approx. 8% orthophosphate and 15% disphosphate are produced by hydrolysis. In the production of pentasodium triphosphate, phosphoric acid is reacted with a soda solution or sodium hydroxide in the stoichiometric ratio, and the solution is dewatered by spraying. Like Graham salt and sodium diphosphate, pentasodium triphosphate dissolves many insoluble metal compounds (including lime soaps, etc.). Pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing-detergent and cleaning-agent industry. Sodium potassium tripolyphosphates also exist and are likewise usable in the context of the present invention. They are produced, for example, when sodium trimetaphosphate is hydrolyzed with KOH:

(NaPO₃)₃+2KOH→Na₃K₂P₃O₁₀+H₂O

These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable according to the present invention.

With regard to component e), 1.5 wt % to 5 wt % polymeric polycarboxylate, selected in particular from the polymerization or copolymerization products of acrylic acid, methacrylic acid, and/or maleic acid, are contained in a preferred embodiment of compositions according to the present invention. Among these, the homopolymers of acrylic acid, and among the latter in turn those having an average molecular weight in the range from 5000 D to 15,000 D (PA standard), are particularly preferred.

Possibilities as enzymes usable in the composition are, in addition to the aforesaid oxidases, those from the class of the proteases, lipases, cutinases, amylases, pullulanases, mannanases, cellulases, hemicellulases, xylanases, and peroxidases, as well as mixtures thereof, for example proteases such as BLAP®, Optimase®, Opticlean®, Maxacal®, Maxapem®, Alcalase®, Esperase®, Savinase®, Durazym® and/or Purafect® OxP, amylases such as Termamyl®, Amylase-LT®, Maxamyl®, Duramyl® and/or Purafect® OxAm, lipases such as Lipolase®, Lipomax®, Lumafast® and/or Lipozym®, cellulases such as Celluzyme® and/or Carezyme®. Enzymatic active substances recovered from fungi or bacteria, such as Bacillus subtilis, Bacillus licheniformis, Streptomyces griseus, Humicola lanuginosa, Humicola insolens, Pseudomonas pseudoalcaligenes, or Pseudomonas cepacia, are particularly suitable. The enzymes that are optionally used can be adsorbed onto carrier substances and/or embedded into encasing substances in order to protect them from premature inactivation. They are contained in the washing detergents, cleaning agents, and disinfecting agents according to the present invention by preference in quantities up to 10 wt %, in particular from 0.2 wt % to 2 wt %, enzymes stabilized against oxidative breakdown being used with particular preference.

In a preferred embodiment of the invention, the composition contains 5 wt % to 50 wt %, in particular 8 to 30 wt %, anionic and/or nonionic surfactant, up to 60 wt %, in particular 5 to 40 wt %, builder substance, and 0.2 wt % to 2 wt % enzyme, selected from the proteases, lipases, cutinases, amylases, pullulanases, mannanases, cellulases, oxidases, and peroxidases as well as mixtures thereof.

In order to establish a desired pH that does not result of itself from the mixture of the remaining components upon the addition of water, the compositions according to the present invention can contain system-compatible and environmentally compatible acids, in particular citric acid, acetic acid, tartaric acid, malic acid, lactic acid, glycolic acid, succinic acid, glutaric acid, and/or adipic acid, but also mineral acids, in particular sulfuric acid, or bases, in particular ammonium hydroxide or alkali hydroxides. pH regulators of this kind are contained in the compositions according to the present invention by preference at no more than 20 wt %, in particular from 1.2 wt % to 17 wt %.

Soil-release-enabling polymers, which are often referred to as “soil release” active substances, or as “soil repellents” because of their ability to make the treated surface (for example, of the fibers) soil-repellent, are, for example, nonionic or cationic cellulose derivatives. Included among the, in particular, polyester-active soil-release-enabling polymers are copolyesters of dicarboxylic acids, for example adipic acid, phthalic acid or terephthalic acid, diols, for example ethylene glycol or propylene glycol, and polydiols, for example polyethylene glycol or polypropylene glycol. Included among the soil-release-enabling polyesters preferred for use are those compounds that are accessible formally by the esterification of two monomer parts, the first monomer being a dicarboxylic acid HOOC-Ph-COOH and the second monomer being a diol HO—(CHR¹¹—)ₐOH, which can also be present as a polymeric diol H—(O—(CHR¹¹—)ₐ)_{b}OH, in which Ph denotes an o-, m-, or p-phenylene group that can carry 1 to 4 substituents selected from alkyl groups having 1 to 22 carbon atoms, sulfonic acid groups, carboxyl groups, and mixtures thereof, R¹¹ denotes hydrogen, an alkyl group having 1 to 22 carbon atoms, and mixtures thereof, a is a number from 2 to 6, and b is a number from 1 to 300. By preference, both monomer diol units —O—(CHR¹¹—)ₐ)_{b}O— and polymer diol units —(O—(CHR¹¹—)ₐ)_{b}O— are present in the polyesters obtainable therefrom. The molar ratio of monomer diol units to polymer diol units is by preference 100:1 to 1:100, in particular 10:1 to 1:10. In the polymer diol units, the degree of polymerization b is preferably in the range from 4 to 200, in particular from 12 to 140. The molecular weight or average molecular weight, or the maximum of the molecular weight distribution, of preferred soil-release-enabling polyesters is in the range from 250 to 100,000, in particular from 500 to 50,000. The acid on which the Ph group is based is selected by preference from terephthalic acid, isophthalic acid, phthalic acid, trimellitic acid, mellitic acid, the isomers of sulfophthalic acid, sulfoisophthalic acid, and sulfoterephthalic acid, and mixtures thereof. If their acid groups are not part of the ester bonds in the polymer, they are preferably present in salt form, in particular as an alkali or ammonium salt. Among these, the sodium and potassium salts are particularly preferred. If desired, instead of the HOOC-Ph-COOH monomer, small proportions—in particular no more than 10 mol % based on the proportion of Ph having the meaning indicated above—of other acids that comprise at least two carboxyl groups can be contained in the soil-release-enabling polyester. Included among these are, for example, alkylene and alkenylene dicarboxylic acids such as malonic acid, succinic acid, fumaric acid, maleic acid, glutaric acid, adipic acid, pimelic acid, suberic acid, azelaic acid, and sebacic acid. Included among the preferred diols HO—(CHR¹¹—)ₐOH are those in which R¹¹ is hydrogen and a is a number from 2 to 6, and those in which a has the value of 2 and R¹¹ is selected from hydrogen and the alkyl groups having 1 to 10, in particular 1 to 3, carbon atoms. Among the last-named diols, those of the formula HO—CH₂—CHR¹¹—OH, in which R¹¹ has the meaning indicated above, are particularly preferred. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol, and neopentyl glycol. Polyethylene glycol having an average molar weight in the range from 1000 to 6000 is particularly preferred among the polymeric diols. If desired, these polyesters can also be end-capped, alkyl groups having 1 to 22 carbon atoms and esters of monocarboxylic acids being suitable as terminal groups. The terminal groups, bound via ester bonds, can be based on alkyl, alkenyl, and aryl monocarboxylic acids having 5 to 32 carbon atoms, in particular 5 to 18 carbon atoms. Included among these are valeric acid, hexanoic acid, oenanthic acid, octanoic acid, pelargonic acid, decanoic acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, that can carry 1 to 5 substituents having a total of up to 25 carbon atoms, in particular 1 to 12 carbon atoms, for example tert.-butylbenzoic acid. The terminal groups can also be based on hydroxymonocarboxylic acids having 5 to 22 carbon atoms, included among which are, for example, hydroxyvaleric acid, hydroxyhexanoic acid, ricinoleic acid, its hydrogenation product hydroxystearic acid, and o-, m-, and p-hydroxybenzoic acid. The hydroxymonocarboxylic acids can in turn be connected to one another via their hydroxyl group and their carboxyl group, and can thus be present more than once in a terminal group. By preference, the number of hydroxymonocarboxylic acid units per terminal group, i.e. their degree of oligomerization, is in the range from 1 to 50, in particular from 1 to 10. In a preferred embodiment of the invention, polymers of ethylene terephthalate and polyethylene oxide terephthalate, in which the polyethylene glycol units have molecular weights from 750 to 5000 and the molar ratio of ethylene terephthalate to polyethylene oxide terephthalate is 50:50 to 90:10, are used alone or in combination with the cellulose derivatives.

The color transfer inhibitors that are suitable for use in compositions according to the present invention for laundering textiles include, in particular, polyvinylpyrrolidones, polyvinylimidazoles, polymeric N-oxides such as poly(vinylpyridine-N-oxide), and copolymers of vinylpyrrolidone with vinylimidazole and, optionally, further monomers.

Because textile fabrics, in particular those made of rayon, viscose, cotton, and mixtures thereof, can tend to wrinkle because the individual fibers are sensitive to bending, kinking, compression, and squeezing perpendicularly to the fiber direction, the compositions according to the present invention for use in textile laundering can contain wrinkle-prevention agents. These include, for example, synthetic products based on fatty acids, fatty acid esters, fatty acid amides, fatty acid alkylol esters, fatty acid alkylolamides, or fatty alcohols that are usually reacted with ethylene oxide, or products based on lecithin or modified phosphoric acid esters.

The purpose of graying inhibitors is to keep dirt that has been detached from the hard surface, and in particular from the textile fibers, suspended in the washing bath. Water-soluble colloids, usually organic in nature, are suitable for this, for example glue, gelatin, salts of ethercarboxylic acids or ethersulfonic acids of starch or of cellulose, or salts of acid sulfuric acid esters of cellulose or of starch. Water-soluble polyamides containing acid groups are also suitable for this purpose. Starch products other than those cited above can also be used, for example aldehyde starches. Cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, and mixtures thereof are preferred for use, for example, in quantities from 0.1 to 5 wt % based on the composition.

The compositions can contain optical brighteners, among them in particular derivatives of diaminostilbenedisulfonic acid or its alkali metal salts. Suitable, for example, are salts of 4,4′-bis(2-anilino-4-morpholino-1,3,5-triazinyl-6-amino)stilbene-2,2′-disulfonic acid, or compounds of similar structure that carry, instead of the morpholino group, a diethanolamino group, a methylamino group, an anilino group, or a 2-methoxyethylamino group. Brighteners of the substituted diphenylstyryl type can also be present, e.g. the alkali salts of 4,4′-bis(2-sulfostyryl)diphenyl, of 4,4′-bis(4-chloro-3-sulfostyryl)diphenyl, or of 4-(4-chlorostyryl)-4′-(2-sulfostyryl)diphenyl. Mixtures of the aforesaid optical brighteners can also be used.

For use especially in automatic washing and cleaning methods, it can be advantageous to add usual foam inhibitors to the compositions. Suitable as foam inhibitors are, for example, soaps of natural or synthetic origin that have a high proportion of C₁₈ to C₂₄ fatty acids. Suitable non-surfactant foam inhibitors are, for example, organopolysiloxanes and mixtures thereof with microfine, optionally silanated silicic acid, as well as paraffins, waxes, microcrystalline waxes, and mixtures thereof with silanated silicic acid or bis-fatty acid alkylenediamides. There are also advantages to using mixtures of different foam inhibitors, for example those made of silicones, paraffins, or waxes. The foam inhibitors, in particular silicone- or paraffin-containing foam inhibitors, are preferably bound to a granular carrier substance that is soluble or dispersible in water. Mixtures of paraffins and bistearylethylenediamide are particularly preferred in this context.

Active substances to prevent the tarnishing of objects made of silver, so-called silver corrosion inhibitors, can additionally be used in compositions according to the present invention. Preferred silver corrosion protection agents are organic disulfides, divalent phenols, trivalent phenols, optionally alkyl- or aminoalkyl-substituted triazoles such as benzotriazole, and salts and/or complexes of cobalt, manganese, titanium, zirconium, hafnium, vanadium, or cerium in which the aforesaid metals are present in one of the oxidation states II, III, IV, V, or VI.

In order to intensify the disinfecting effect with regard to specific germs, a composition according to the present invention can contain usual antimicrobial active substances in addition to the ingredients hitherto recited. Such antimicrobial additives are contained in compositions according to the present invention by preference in quantities of up to 10 wt %, in particular from 0.1 wt % to 5 wt %.

A cleaning agent according to the present invention for hard surfaces can furthermore contain abrasively acting constituents, in particular from the group encompassing quartz flours, wood flours, plastic flours, chalks, and glass microspheres, and mixtures thereof. Abrasive substances are contained in the cleaning agents according to the present invention by preference at no more than 20 wt %, in particular from 5 wt % to 15 wt %.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

What is claimed:

1. A solid washing detergent or cleaning agent, comprising particles comprising an alkali percarbonate and having an average particle size of 1.0 mm to 2.0 mm, and particles comprising a bleach-intensifying transition metal complex compound and having an average particle size of 0.8 mm to 1.6 mm.

2. The composition of claim 1, wherein the particles comprising the alkali percarbonate have an average particle size of 0.05 mm to 0.4 mm larger than the average particle size of the particles comprising the bleach-intensifying transition metal complex compound.

3. The composition of claim 2, wherein the particles comprising the alkali percarbonate have an average particle size of 0.1 mm to 0.25 mm larger than the average particle size of the particles comprising the bleach-intensifying transition metal complex compound.

4. The composition of claim 1, further comprising one or more additional particulate components having an average particle size of 1.0 mm to 2.0 mm.

5. The composition of claim 4, further comprising one or more additional particulate components having an average particle size of 1.2 mm to 1.8 mm.

6. The composition of claim 1, wherein less than 10% by weight of the particles comprising the alkali percarbonate have a diameter of greater than 2.0 mm.

7. The composition of claim 6, wherein less than 5% by weight of the particles comprising the alkali percarbonate have a diameter of greater than 2.0 mm.

8. The composition of claim 1, wherein less than 40% by weight of the particles comprising the alkali percarbonate have a diameter of less than 1.0 mm.

9. The composition of claim 7, wherein less than 35% by weight of the particles comprising the alkali percarbonate have a diameter of less than 1.0 mm.

10. The composition of claim 1, wherein at least 80% by weight of the particles comprising the bleach-intensifying transition metal complex compound have a particle size of 0.8 mm to 1.6 mm.

11. The composition of claim 10, wherein at least 85% by weight of the particles comprising the bleach-intensifying transition metal complex compound have a particle size of 0.8 mm to 1.6 mm.

12. The composition of claim 1, wherein less than 20% by weight of the particles comprising the bleach-intensifying transition metal complex compound have a particle size of less than 0.8 mm.

13. The composition of claim 1, comprising 0.01% to 0.5% by weight of the bleach-intensifying transition metal complex compound.

14. The composition of claim 13, comprising 0.02% to 0.3% by weight of the bleach-intensifying transition metal complex compound.

15. The composition of claim 1, comprising 15% to 50% by weight of the alkali percarbonate.

16. The composition of claim 15, comprising 18% to 35% by weight of the alkali percarbonate.

17. The composition of claim 1, comprising 15% to 35% by weight of the alkali percarbonate, 60% to 80% by weight of a particulate alkali carbonate, up to 5% by weight of one or more complexing agents for heavy metals, and 0.5% to 5% by weight of the bleach-intensifying transition metal complex compound.

18. The composition of claim 1, wherein the bleach-intensifying transition metal complex compound comprises a manganese complex of formula (I): 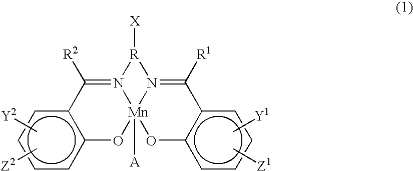
in which
R denotes an alkylene, alkenylene, phenylene, or cycloalkylene group that in addition to the substituent X can, optionally, be alkyl- and/or aryl-substituted, having a total of 1 to 12 carbon atoms, the shortest spacing within R between the nitrogen atoms being 1 to 5 carbon atoms,
X denotes —H, —OR³, —NO₂, —F, —Cl, —Br, or —I;
R¹, R², and R³ mutually independently, denote hydrogen or an alkyl group having 1 to 4 carbon atoms;
Y¹ and Y² mutually independently, denote hydrogen or an electron-shifting substituent;
Z¹ and Z² mutually independently, denote hydrogen, —CO₂M, —SO₃M, or NO₂;
M denotes hydrogen or an alkali metal such as lithium, sodium, or potassium; and
A denotes a charge-equalizing anion ligand that, depending on its charge and on the nature and number of the other charges, in particular the charge of the central manganese atom, can also be absent or can be present more than once.

19. The composition of claim 1, wherein the bleach-intensifying transition metal complex compound comprises a manganese complex of the formula:

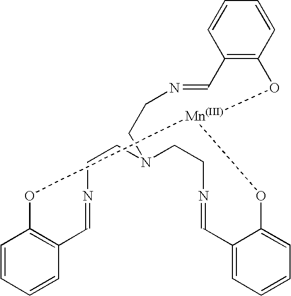

20. The composition of claim 1, wherein the bleach-intensifying transition metal complex compound comprises a manganese complex of formula (II): 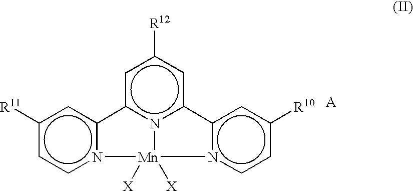
in which R¹⁰ and R¹¹, mutually independently, denote hydrogen, a C₁₋₁₈ alkyl group, an —NR¹³R¹⁴ group, an —N⁺R¹³R¹⁴R¹⁵ group, or a 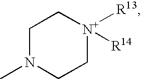
group, R¹² denotes hydrogen, —OH, or a C₁₋₁₈ alkyl group, R¹³, R¹⁴, and R¹⁵ mutually independently, denote hydrogen, a C₁₋₄ alkyl or hydroxyalkyl group, and X denotes halogen, and A denotes a charge-equalizing anion that, depending on its charge and on the nature and number of the other charges, in particular the charge of the central manganese atom, can also be absent or can be present more than once.
